(19) United States
(12) Patent Application Publication
(10) Pub. No.: US 2026/0285484 A1
(43) Pub. Date: Sep. 24, 2026

(54) WIRELESS CONTROL UNIT FOR AIRCRAFT PASSENGERS, OPERATIONAL DURING ALL FLIGHT PHASES, AND SYSTEM COMPRISING SUCH A UNIT

(71) Applicant: AIRBUS ATLANTIC, Rochefort (FR)

(72) Inventor: Serge SANDANAM, Rochefort (FR)

(21) Appl. No.: 19/569,209

(22) Filed: Mar. 17, 2026

(30) Foreign Application Priority Data
Mar. 18, 2025 (FR) FR2502751

(51) Int. Cl. B64D 11/00

(52) U.S. Cl. CPC B64D 11/00155

(57) ABSTRACT

A control unit for allowing an aircraft passenger to control their seat environment including a touchscreen tablet communicating wirelessly with a docking station configured to receive the tablet. The docking station is connected to an SFCU and an IFE system. The touchscreen tablet transmits both seat actuation commands and entertainment commands to the docking station. The docking station integrates a mediation module carrying out a separation between actuation commands and entertainment commands. The mediation module routes the actuation commands to the SFCU, and directs the entertainment commands directly to the IFE system via a dedicated link, thus ensuring continuous operation during all phases of the flight.

### CROSS REFERENCE TO RELATED APPLICATION

This application claims priority to French Patent Application Number FR 2502751, filed March 18, 2025, the entire contents of which is hereby incorporated by reference.

### TECHNICAL FIELD

The present disclosure relates to the field of control systems for aircraft passenger seat and its environment, in particular wireless control systems. More particularly, it relates to a wireless control unit operational during all flight phases and a system comprising this unit. Wireless passenger control units are better known in commercial aviation jargon by their acronym WPCU (wireless passenger control unit).

The disclosure has a direct, but not exclusive, application in higher airliner classes (business class and first class).

### PRIOR ART

Historically, the evolution of passenger control systems in the aviation industry has followed a trajectory marked by the gradual integration of increasingly sophisticated technologies, always in pursuit of greater comfort and convenience. The first on-board devices were limited to rudimentary keypads or control panels, often located in the armrest, which only allowed for seat tilt adjustment or calling cabin crew. Subsequently, the introduction of touchscreens has enabled passengers to access an increasing number of functions, such as light adjustment, IFE (in-flight entertainment) management and fine configuration of the seat position. Following on from these developments, wireless passenger control units (WPCUs) have been introduced, which offer improved ergonomics thanks to their portability.

From a technical point of view, current passenger control devices often integrate electronic modules dedicated to communicating with the various seat actuators (electric motors, locking mechanisms, individual lighting, etc.). Traditional keypads or touchscreens are usually connected by cables to seat function control units (SFCUs), housed in the seat block or in a central computer system unit. WPCUs, however, rely on wireless communication protocols to transmit commands to the same actuators, via SFCUs, while providing basic security devices to prevent radio interference or loss of synchronization.

Patent FR3107255B1 describes a WPCU for controlling an aircraft seat and its environment via a wireless link, establishing a simplified pairing protocol between a portable electronic device (PED) and an SFCU. In this architecture, the IFE and seat actuation functions are integrated into a single electronic and software chain. The PED used in this solution may be a personal device, which is not compatible with certain cybersecurity constraints.

All of these current solutions generally encounter certification constraints that result in strict limitation of their use during critical flight phases, namely taxiing, take-off and landing, known as TTL (taxi take-off landing).

Indeed, the current systems have a DAL E criticality level, according to standards ED-12C and DO-178C (Software considerations in airborne systems and equipment certification). This low criticality level corresponds to the minimum requirements and implies that systems are not recognized as sufficiently safe to operate continuously during TTL phases or in situations requiring the absence of electrical interference. More specifically, DAL E requires only minimal demonstrations in terms of reliability and fault management, which leads to the neutralization of devices during critical flight phases in order to minimize any potential risks, such as either interference with flight control systems or the inability of passengers to act quickly in an emergency. As a result, even the in-flight entertainment (IFE) functions, which are less likely to compromise safety, are blocked as well as the seat adjustment functions, which are the only ones likely to pose a risk during the TTL phases.

It also appears that the imposed restrictions address safety considerations related to the risk of interaction between radio signals and navigation systems. Therefore, the entertainment and seat adjustment systems are disabled or severely restricted during take-off and landing.

However, this functional restriction, especially during taxiing, take-off and landing, can cause significant discomfort for passengers. During these phases, it is common for some to want to adjust their seats, change the individual lighting to optimize their reading comfort or ask the cabin crew for assistance. Similarly, in premium classes, where convertible seats offer multiple adjustment options, not being able to configure the seat or immediate environment when desired can be a source of frustration. Passengers attach great importance to the continuity of service and the ability to personalize their comfort at any time, such as when interacting with the entertainment system or enjoying a dedicated service during all flight phases.

As a result, there is a clearly identified need for a passenger control system that is not limited by these restrictions, in order to allow uninterrupted use during all flight phases. Airlines that are keen to offer their customers greater comfort and autonomy are looking for solutions that can operate without interruption, while ensuring a level of safety that meets current regulatory standards.

### SUMMARY

The present disclosure aims to overcome all or some of the drawbacks of the prior art set out above by proposing an innovative, DAL D-certified solution, making it possible to control the passenger seat and its environment without interruption in all flight phases (TTL and cruise).

An objective of the disclosure is therefore to implement a partitioned architecture that isolates the critical functions (seat actuation commands) from the non-critical functions (IFE controls). This separation requires the implementation of protection mechanisms both on the software level – through abstraction layers and integrity checks – and on the hardware level, relying on dedicated electronic modules to limit electromagnetic interference.

Another objective of the disclosure is to ensure the robustness of the communication protocol between the different elements, in particular via data verification algorithms, fine latency management and error recovery techniques, in order to respond to the real-time constraints of the avionics environment.

For this purpose, the present disclosure relates to a control unit enabling an aircraft passenger to control their seat environment, said unit comprising a touchscreen tablet capable of wireless communication and a docking station capable of receiving said tablet, said station being configured to be connected to a seat function control unit, referred to as an SFCU, and to an in- flight entertainment system, referred to as an IFE system, the touchscreen tablet being configured to send seat actuation commands and entertainment commands to the docking station. This control unit is remarkable in that the docking station comprises a mediation module configured to operate a segregation between the seat actuation commands and the entertainment commands, and in that the mediation module is configured to route the seat actuation commands to the SFCU connected to the docking station and to route the entertainment commands to the IFE system via a direct link.

According to one embodiment, the SFCU is integrated into the docking station.

According to one embodiment, the direct link is an Ethernet cable and the seat actuation commands are transmitted to the SFCU via CAN data buses.

According to one embodiment, the mediation module comprises hardware and software means for filtering and analyzing the frames exchanged between the touchscreen tablet and the docking station.

More specifically, the hardware and software means of the mediation module comprise at least one smart switch.

According to one embodiment, the control unit further comprises a means for mechanically locking the touchscreen tablet in the docking station, said locking means comprising a servomotor maintaining a locked position in the event of a power failure.

According to one aspect of the disclosure, the mediation module is configured to ensure a functional separation of the data in accordance with level DAL D according to the standard DO-178B.

The disclosure also relates to a system for controlling an aircraft passenger seat environment, comprising a control unit as presented, an SFCU, an IFE system and an electronic control unit, known as an ECU.

According to one embodiment, the SFCU transmits the actuation commands received from the control unit to the ECU, the latter being configured to directly control a set of actuators of the seat environment.

Another object of the disclosure is an aircraft comprising at least one such control system.

The fundamental concepts of the disclosure having been disclosed hereinabove in their most elementary form, other details and features will become more apparent upon reading the following description with reference to the appended drawings, giving, by way of non-limiting example, an embodiment of an aircraft wireless passenger control unit, in accordance with the principles of the disclosure.

### BRIEF DESCRIPTION OF THE DRAWINGS

The figures are given purely by way of illustration for a better understanding of the disclosure without limiting the scope thereof. The different elements may be represented schematically and are not necessarily to scale. Throughout the figures, identical or equivalent elements bear the same reference numeral.

FIG. 1 is a diagram of the architecture of a control unit in a seat control system according to an exemplary embodiment.

FIG. 2 is a perspective view of a control unit installed in a seat environment according to an exemplary embodiment.

FIG. 3 is an example of a graphical interface of a quick command bar on the docking station according to an exemplary embodiment.

FIG. 4 is a perspective view of a seat environment in which a control unit is installed, with a detailed view of this unit according to an exemplary embodiment.

FIG. 5 is a block diagram of the software architecture of the control system.

FIG. 6 is a sequence diagram of an example of how the control unit is used

### DETAILED DESCRIPTION

In the embodiment described below, reference is made to a wireless control unit allowing an aircraft passenger to control their seat and the associated environment. This unit is primarily intended for convertible seats in business and first class.

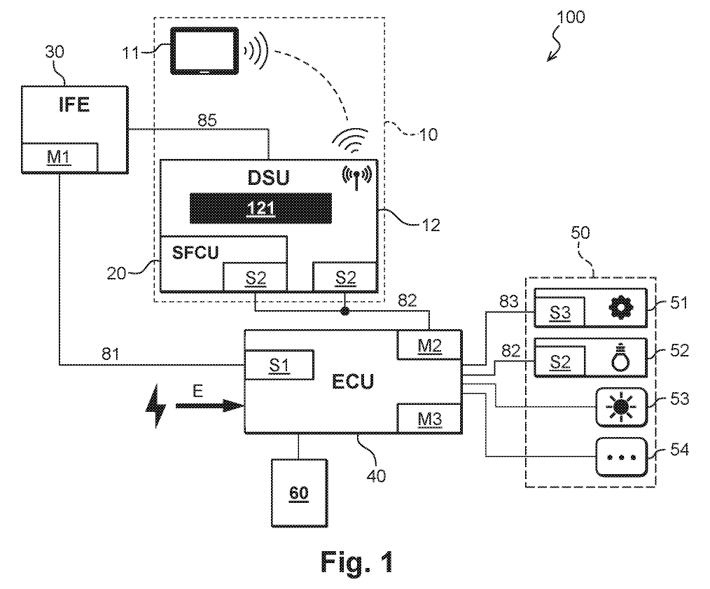

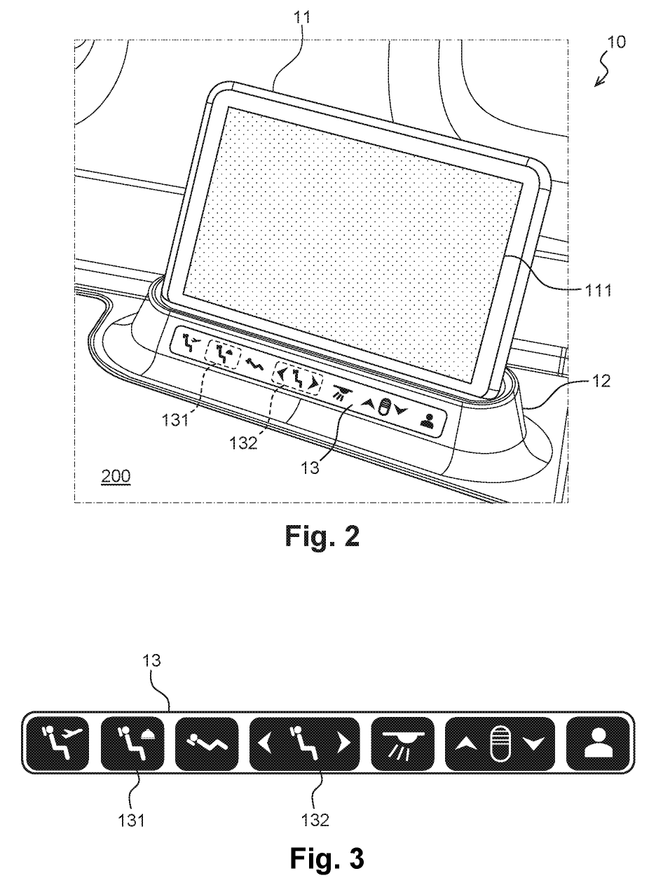

FIG. 1 shows a control unit 10 for a seat and its environment within an aircraft, said unit operating in a more general control system 100. The control unit 10 comprises a touchscreen tablet 11 and a multifunctional docking station 12, known as DSU (docking station unit ), intended to receive the tablet in a storage position, as shown in FIG. 2. This position ensures a physical connection between the tablet 11 and the docking station 12, allowing both an electronic connection for charging the tablet and wired communication via suitable ports, as well as stable mechanical support of the tablet, with the possibility of locking it in place in certain situations.

The touchscreen tablet 11, due to its portability and its possible use outside the docking station 12, is also capable of wirelessly communicating with said station via a radio protocol such as Wi-Fi, Bluetooth or any other low-latency protocol.

The control unit 10 makes it possible, conventionally, to control the seat actuation, via a seat function control unit 20, referred to as SFCU, itself connected to an electronic control unit 40, referred to as ECU, and to control an in-flight entertainment system 30, referred to as IFE. Together, these elements constitute the control system 100.

According to the disclosure, the docking station 12 integrates a hardware and software module 121, hereinafter referred to as “mediation module”, the function of which is to ensure a robust segregation between the data flows related to the IFE 30 and those relating to the seat actuation. This mediation module 121 acts as a firewall or smart switch by filtering and analyzing the frames exchanged between the touchscreen tablet 11 and the other elements to ensure that no undesirable interaction can occur between the critical seat actuation functions and the non-critical entertainment functions. This strict segregation makes it possible to meet the high operational safety and cybersecurity requirements imposed by the avionics environment, in particular by avoiding any mutual interference or cross-contamination between critical and non-critical domains.

In the illustrated example, the touchscreen tablet 11 exclusively sends its commands to the docking station 12. The mediation module 121 then analyzes these commands to determine whether they relate to the seat actuation or IFE services. When the command relates to seat actuation, the mediation module 121 routes the information to the SFCU 20, which is physically connected to the docking station 12 by internal wiring. The SFCU 20 can be integrated into the docking station 12, as here, or be remote from it.

Conversely, when it comes to multimedia or entertainment requests, the mediation module 121 directs the data flow to the IFE system 30 by means of an Ethernet link 85 directly connecting the docking station 12 to said IFE system. This dual orientation of the data is key tor meeting safety and certification requirements, in particular at DAL D, thus allowing the continuous use of the system during all flight phases, including the critical TTL phases.

The SFCU 20 and the IFE system 30 can be connected in a wired manner to the electronic control unit ECU 40 for handling internal data exchanges. In practice, these exchanges use different communication buses, such as a serial digital interface 81, typically according to the standard RS-485 (EIA-485), as well as high-speed 82 and low-speed 83 CAN buses.

In the example shown, these different links operate according to master-slave schemes, represented respectively by the references M1, M2, M3 for the masters and S1, S2, S3 for the slaves. Thus, the pairs S1-M1, S2-M2 and S3-M3 correspond respectively to the master-slave schemes of the links 81, 82 and 83. The links 82 and 83 also comprise provision of electrical power supply on their lines, in addition to the CAN signals.

It should be noted that other communication standards and protocols may be considered as an alternative or in addition, in particular Ethernet, ARINC 429 or AFDX (registered trademark), in order to adapt to different avionics environments or specific requirements of aircraft manufacturers.

The ECU 40 receives the validated commands transmitted by the SFCU 20 and physically controls the seat actuators and effectors grouped together in a set of actuators 50. This set of actuators 50 typically comprises several elements, including mechanical actuators 51 for adjusting and converting the seat, a reading light 52, an ambient light 53, and various other equipment 54 such as local ventilation systems or blind adjustment systems, according to the configurations specific to each comfort class.

The ECU 40 also receives an electrical power supply E, for example from a 115 V AC network in accordance with routine aeronautical standards.

Furthermore, a maintenance port 60 connected to the ECU 40 is provided to allow technical teams to diagnose the overall operation of the system, to carry out software updates or to carry out troubleshooting operations in the event of a malfunction. According to various possible embodiments, this maintenance port 60 may also be directly accessible from the docking station 12, or may be the subject of a secure connection accessible by the touchscreen tablet 11 by means of dedicated software tools.

It should be noted that the architecture detailed here can be adapted in several alternative ways. For example, the mediation module 121 could be physically separated from the docking station 12 and integrated into a separate housing. Similarly, the Ethernet connection 85 connecting the docking station 12 to the IFE 30 system could be replaced by another suitable type of local network.

The control system 100 as described above may be installed on board an aircraft according to different mechanical and spatial integration configurations, depending on the interior design choices and constraints specific to each aircraft model or each comfort class. In particular, the touchscreen tablet 11 and its docking station 12 may be arranged in the immediate vicinity of the passenger seat, so as to allow ergonomic and intuitive access to the controls during all flight phases.

FIG. 2 shows, in this respect, the control unit 10 installed in a passenger seat environment 200, with the tablet 11 placed in its docking station 12, in a housing provided for this purpose. This housing is also equipped with at least one port necessary for connecting and linking the tablet 11.

The tablet 11 comprises a touchscreen display 111 allowing the passenger to access the various control functions available. For example, the screen 111 is an LCD screen with a size of around 10 inches (around 25 centimeters), this size allows good readability and comfortable interaction for the passenger.

Furthermore, the docking station 12 comprises a quick command bar 13 allowing the passenger direct and simplified access to certain preferred functions without necessarily having to interact with the touchscreen. This quick command bar 13 comprises specific functional buttons such as a button 131 for direct calling of the meal or refreshment service, and a button 132 for adjusting the inclination of the seat.

Of course, other functional buttons are provided on this quick command bar 13, according to the choices and preferences of the airline or aircraft manufacturers, and may include, for example, the control of the individual lighting, ventilation, calling cabin screw, adjusting the blinds, or even a direct access key to IFE services. These buttons are preferably configurable by the user or according to pre-programmed settings according to the comfort classes and the specificities of the seat on which the control unit 10 is installed.

FIG. 3 shows an example of a quick command bar 13, comprising a series of icons allowing direct access to priority functions or those used frequently by passengers. For example, the button 131 triggers a direct command to the flight crew to request a service such as a meal or drink, while the button 132 allows a quick adjustment of the seat position, such as reclining to a relaxed position. Other buttons provide quick access to fine adjustments of the seat position (backrest angle, leg rest height), direct control of the individual reading light or activation of a TTL mode.

The touchscreen tablet 11 may comprise, in some embodiments, a light or visual indicator for informing the user about its operational status, charge level or even the connection status with the docking station 12.

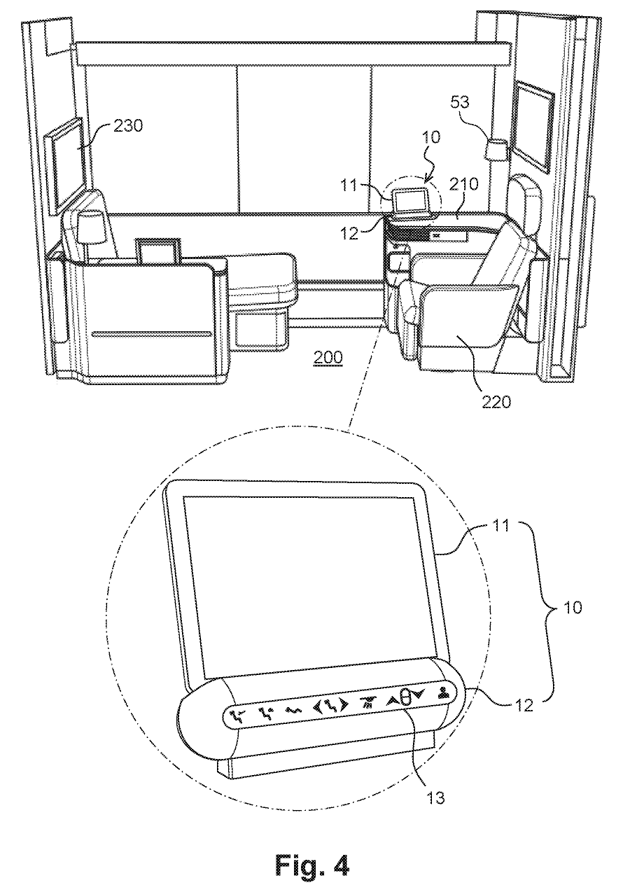

FIG. 4 shows an example of installation of the control unit 10 in an specific aircraft interior layout, and more specifically in a seat environment 200 typically corresponding to an individual space in first class.

In this arrangement, the control unit 10 is installed on a console 210 adjacent to a passenger seat 220, so as to be within immediate reach of the passenger. This particular arrangement facilitates access to the touchscreen tablet 11 and its docking station even when the passenger is in the seated position.

According to the illustrated example, the seat environment 200 also integrates other general passenger comfort equipment. This equipment features in particular an individual screen 230 for displaying multimedia content and IFE system programs. Similarly, the environment 200 comprises an ambient light 53, positioned to provide adjustable illumination of the area occupied by the passenger.

Before describing more specifically an operating sequence of the control system, a particular example of the electronic architecture of the system is given below. This example is of course non-limiting and only reflects one approach among others.

### Example

The control unit 10 according to the disclosure, which comprises the touchscreen tablet 11 as well as the docking station 12 and which is specially configured to ensure secure communication between said tablet and the onboard systems associated with the passenger seat environment, has an architecture at the core of which is the mediation module 121, integrated in the docking station and comprises mainly a central microcontroller of the STM32H750 type. This microcontroller provides advanced and dynamic processing of commands sent by the touchscreen tablet.

The touchscreen tablet integrates an onboard processor ensuring local processing of user interactions, display via a high-resolution LCD touchscreen with LVDS interface, and wireless communication via a dedicated Wi-Fi module. This tablet also has an integrated memory (SD card) as well as specialized circuits for autonomous power supply, regulated by a smart battery with an advanced energy management and electronic monitoring system (multiple voltage regulators, voltage-current monitoring).

When it communicates with the docking station, the tablet transmits commands via a secure wireless (Wi-Fi) connection or via a direct wired Ethernet connection when it is “docked” (storage position). These commands are received by the microcontroller in the mediation module, which determines specifically their type: commands for seat operation or commands for in-flight entertainment (IFE). The microcontroller then processes the actuation commands by routing them to the SFCU via a secure and dedicated CAN bus, thus enabling precise control of the seat actuators and effectors such as motors, lights or other comfort devices.

In parallel, the microcontroller directs entertainment commands to an Ethernet managed switch. This Ethernet switch, combined with magnetic circuits providing galvanic isolation, allows a direct and protected link to the IFE system via a dedicated Ethernet connection, thus ensuring the necessary physical and logical separation between critical and non-critical flows.

This combined hardware and software architecture, grouped within the mediation module, ensures complete segregation between critical flows (seat actuation) and non-critical flows (IFE services). It thus meets the strict requirements of DAL D certification, enabling the safe and uninterrupted use of the control unit by the passenger during all flight phases, including critical taxiing, take-off and landing phases.

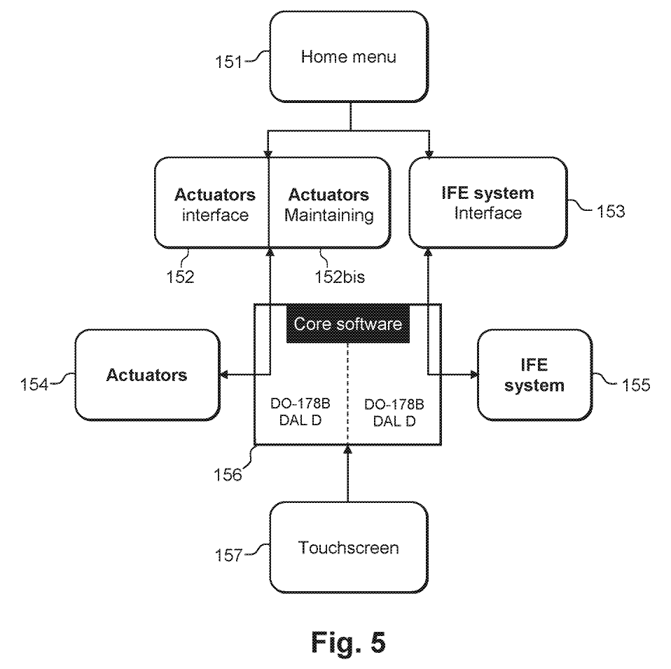

FIG. 5 shows a software architecture of the control unit according to the disclosure, developed to meet the strict requirements of avionics safety DAL D according to the standard DO-178B.

From a home menu 151, the user accesses three main software packages: a user interface dedicated to controlling the actuators 152, a specific software for maintaining the actuators 152bis, as well as a user interface dedicated to in-flight entertainment, referred to as the IFE 153 user interface.

These software modules interact directly with core software 156, which is the central mediation element of the system. This core software 156 is specifically designed to comply with the avionics standards DO-178B at level DAL D, ensuring high reliability and robustness against potential software errors.

The core software 156 carries out a strict separation between the critical flows intended for the actuator software 154 and the non-critical flows intended for the IFE system software 155. It ensures the validated controls for the actuators 154 and those for the IFE system 155 remain strictly isolated, preventing any cross-contamination or undesirable interference between these two functional areas.

The software package also integrates a touchscreen configuration software module 157, allowing touch interactions to be configured according to specific features of the seat or air carrier preferences. This software communicates directly with the core software 156 to ensure the ergonomic and functional consistency of user commands and interactions.

This highly segregated modular architecture thus allows safe and continuous use of the control unit during all flight phases, in particular during the critical TTL phases.

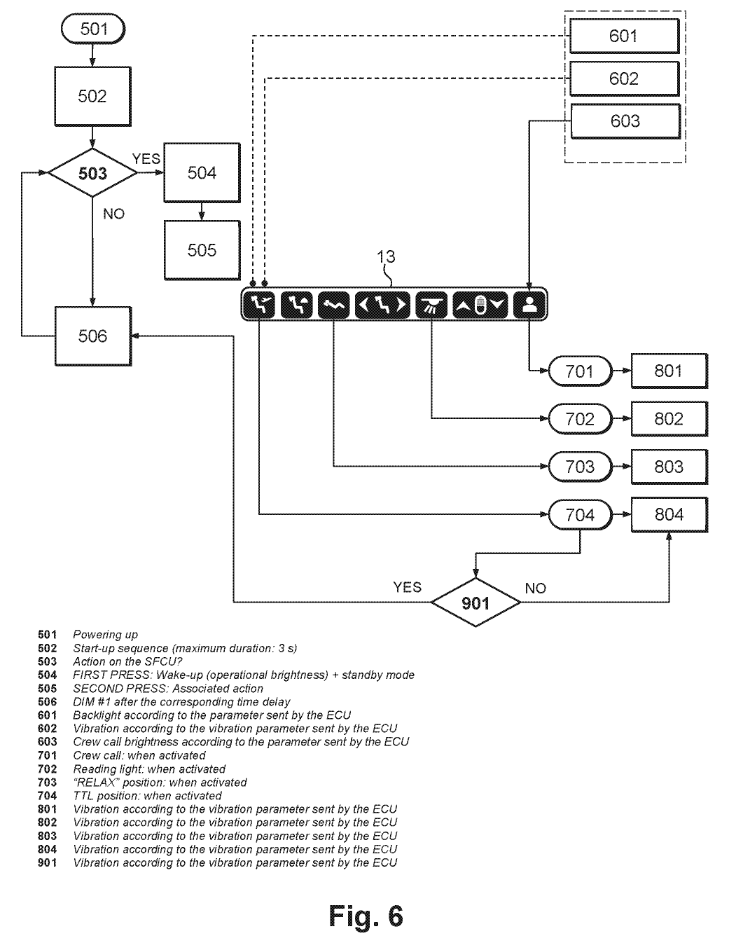

FIG. 6 shows a simplified diagram describing an example of a logical command process associated with the use of the quick command bar 13. This diagram illustrates the functional sequence from powering up 501 the device to the actual execution of a command. After initial power-up, a sequence of starts 502 not exceeding 3 seconds is initiated in order to make the SFCU fully operational. A check 503 is then used to determine whether an action on the SFCU has been detected.

If an action is actually detected (yes), a first press 504 on one of the touch buttons activates the SFCU, in particular waking up the backlight in operational mode (normal brightness). A second press 505 on this same button causes the associated action to be performed, such as a seat, lighting or crew call command. If one of the buttons is not pressed, the device activates a first gradual light dimming mode (DIM #1) 506 after a certain time.

Furthermore, the command bar benefits from optimized management of the touch ergonomics: its backlight 601 is configured by the electronic control unit ECU, a vibration (haptic feedback) 602 is triggered according to a specific parameter defined by the ECU in order to inform the user that their command has been accepted, and the light intensity of the crew call button 603 is also adjusted according to parameters transmitted by the ECU.

More specifically, different commands can be selected by the user: call cabin crew 701, control the reading light 702, adjust the seat 703 to the “RELAX” position or activate TTL mode 704. Each press associated with these controls systematically generates haptic feedback in the form of a vibration set by the ECU, 801, 802, 803 and 804 respectively.

Finally, an additional check 901 validates the end of the action on the SFCU and determines, according to the parameters transmitted by the ECU, whether a new confirmation vibration should be emitted.

Furthermore, the control unit 10 comprises a mechanical locking system (not shown) for securing the touchscreen tablet 11 in its docking station 12, making it possible to ensure both safety during the critical flight phases (TTL) and effective protection against possible theft by passengers.

In the solutions known from the prior art, this locking is traditionally achieved using an electromagnet that releases the tablet in the event of accidental power failure, thus exposing the tablet to a risk of falling.

According to the disclosure, the docking station comprises a locking mechanism based on the use of a servomotor coupled to a mechanical sliding or rotary lock system, configured to maintain a stable closed and locked position even in the event of a total loss of power. For example, this servomotor is combined with an irreversible gear or worm gear, whose geometry mechanically prevents any spontaneous return to an open position in the absence of an explicit electrical command.

During normal operation, the servomotor receives an electrical command from an electronic unit integrated into the docking station, for example controlled directly by the ECU or SFCU, to engage or disengage the locked position according to the flight phase and procedures defined by the airline. When the tablet is positioned in its docking station, the locking command causes the rotation or translation of the mechanism, thus moving a hook or equivalent element into a stable engagement position with a complementary element located on the touch tablet itself.

In the event of a power failure or accidental interruption of the power supply, the mechanism remains stable in the locked position, unlike traditional electromagnetic solutions.

To unlock the tablet, an explicit command, e.g. generated from a specific electronic authorization, activates the servomotor in the opposite direction, causing the tablet to release mechanically.

1. A control unit configured to allow an aircraft passenger to control their seat environment, comprising:
a touchscreen tablet configured to communicate wirelessly;
a docking station configured to receive the tablet;
wherein the docking station is configured to be connected to a seat function control unit (SFCU), and to an in-flight entertainment (IFE) system;
wherein the touchscreen tablet is configured to send seat actuation commands and entertainment commands to the docking station;
wherein the docking station comprises a mediation module configured to segregate the seat actuation commands from the entertainment commands; and,
wherein the mediation module is configured to route the seat actuation commands to the (SFCU) connected to the docking station and to route the entertainment commands to the (IFE) system via a direct link.

2. The control unit according to claim 1, wherein the SFCU is integrated in the docking station.

3. The control unit according to claim 1, wherein the direct link is an Ethernet cable and wherein the seat actuation commands are transmitted to the SFCU via CAN data buses.

4. The control unit according to claim 1, wherein the mediation module comprises hardware and software for filtering and analyzing frames exchanged between the touchscreen tablet and the docking station.

5. The control unit according to claim 4, wherein the hardware and software means of the mediation module comprise at least one smart switch.

6. The control unit according to claim 1, further comprising a means for mechanically locking the touchscreen tablet in the docking station, wherein the locking means comprises a servomotor maintaining a locked position in the event of a power failure.

7. A control system for a seat environment of an aircraft passenger, comprising the control unit according to claim 1, and an electronic control unit (ECU).

8. The control system according to claim 7, wherein the SFCU transmits actuation commands received from the control unit to the ECU, wherein the ECU is configured to directly control a set of actuators of the seat environment.

9. An aircraft, comprising at least one control system according to claim 7.
